(19) United States
(12) Patent Application Publication
(10) Pub. No.: US 2009/0047496 A1
(43) Pub. Date: Feb. 19, 2009

(54) Multilayer fabric and manufacturing method thereof

(76) Inventor: Robert A. Hansen, Stuttgart-Birkach (DE)

Correspondence Address: FROMMER LAWRENCE & HAUG, 745 FIFTH AVENUE- 10TH FL., NEW YORK, NY, 10151, US

(21) Appl. No.: 11/893,874

(22) Filed: Aug. 16, 2007

(51) Int. Cl. B29C 53/00; B29C 65/00; D03D 15/00

(52) U.S. Cl. 428/221; 156/217; 156/443; 442/181; 442/327

(57) ABSTRACT

The invention is directed to a method and machine for manufacturing an industrial fabric using a “folding” technique. The invention relates to a laminated fabric that is produced using this technique. The method comprises the steps of forming a base support structure having a width which is larger than a width of the final fabric, attaching at least one layer of staple fiber batt material to one or both sides of the base support structure, folding the base support structure onto itself in a widthwise manner one or more times to form a multi-layered structure, and bonding the layers of the multilayered structure together to form a laminated fabric structure.

### BACKGROUND

1. Field of the Invention

The present invention relates generally to industrial fabrics, such as for example paper machine clothing (“PMC”) used in the papermaking industry, which is produced by way of a “folding” technique.

2. Background Discussion

The instant invention relates broadly to papermaking machine clothing, substrates for process belts such as shoe press belts, calender belts, transfer belts, and other industrial textile process finishing fabrics/belts such as tannery sleeves. The instant invention is particularly but not exclusively applicable to press fabrics or belts used in the press section of a papermaking machine, but it may also find application in the forming and drying sections of a papermaking machine. While many uses of the industrial fabrics are contemplated, the following invention is related to papermaking fabrics for purposes of illustration.

During the papermaking process, a cellulosic fibrous web is formed by depositing a fibrous slurry, that is, an aqueous dispersion of cellulose fibers, onto a moving forming fabric in the forming section of a papermaking machine. A large amount of water is drained from the slurry through the forming fabric, leaving the cellulosic fibrous web on the surface of the forming fabric.

The newly formed cellulosic fibrous web proceeds from the forming section to a press section that includes a series of press nips. The cellulosic fibrous web passes through the press nips supported by a press fabric, or, as is often the case, between two such press fabrics. In the press nips, the cellulosic fibrous web is subjected to compressive forces which squeeze water therefrom, and which adhere the cellulosic fibers in the web to one another to turn the cellulosic fibrous web into a paper sheet. The water is accepted by the press fabric or fabrics and, ideally, does not return to the paper sheet.

The paper sheet finally proceeds to a dryer section, which includes at least one series of rotatable dryer drums or cylinders, which are internally heated by steam. The newly formed paper sheet is sequentially directed in a serpentine path around each in the series of drums by a dryer fabric, which holds the paper sheet closely against the surfaces of the drums. The heated drums reduce the water content of the paper sheet to a desirable level through evaporation.

It should be appreciated that forming, press and dryer fabrics all take the form of endless loops on the papermaking machine and function in the manner of conveyors. It should further be appreciated that paper manufacture is a continuous process which proceeds at considerable speeds. That is to say, the fibrous slurry is continuously deposited onto the forming fabric in the forming section, while a newly manufactured paper sheet is continuously wound onto rolls after it exits from the dryer section.

Press fabrics are usually made of yarn material woven as a base support structure and are endless in the machine direction (MD) (i.e. in the running direction of the press fabric in the papermaking machine) and include one or more layers of fiber material that are arranged on a base support structure. As used herein, “fiber material” includes all types of staple fibers and the like that can be used in a press fabric or belt.

Press fabrics play a critical role during the papermaking process. As previously discussed, their main function is to absorb the water expressed from the paper sheet in the press nip. Additional functions of the press fabric include: supporting the paper sheet in the press nips to prevent crushing; providing uniform pressure distribution to the paper sheet in the nip; imparting a desirable surface finish to the paper sheet; equalizing pressure distribution over void and land areas of the press roll to eliminate or reduce shadow marking caused by grooved or suction press rolls; transferring the paper sheet from one position to another; and acting as a power transmission belt, driving all undriven rolls in the press section.

Contemporary fabrics are used in a wide variety of styles designed to meet the requirements of the papermaking machines on which they are installed for the paper grades being manufactured. Generally, they comprise yarns woven as a base fabric, which then may include a needled batting of nonwoven fibrous material. The base fabrics may be woven from monofilament, plied monofilament, multifilament or plied multifilament yarns, and may be single-layered, multi-layered or laminated. The yarns are typically extruded from any one of several synthetic polymeric resins, such as polyamide, used for this purpose by those of ordinary skill in the papermaking machine clothing arts.

Woven fabrics take many different forms. For example, they may be woven endless, or flat woven and subsequently rendered into endless form with a seam. Alternatively, they may be produced by a process commonly known as modified endless weaving, wherein the widthwise edges of the base fabric are provided with seaming loops using the machine direction (MD) yarns thereof. In this process, the MD yarns weave continuously back and forth between the widthwise edges of the fabric, at each edge turning back and forming a seaming loop. A base fabric produced in this fashion is placed into endless form during installation on a papermaking machine, and for this reason is referred to as an on-machine-seamable fabric. To place such a fabric into endless form, the two widthwise edges are seamed together by interdigitating the seaming loops at the two ends of the fabric, and by directing a so-called pin, or pintle, through the passage defined by the interdigitated seaming loops in order to lock the two ends of the fabric together.

Further, the woven base fabrics may be laminated by placing one base fabric within the endless loop formed by another, and in the case of press fabrics, by needling staple fiber through both base fabrics to join them to each other, such as that disclosed in commonly assigned U.S. Pat. No. 5,360,656 to Rexfelt et al. (hereinafter “the '656 patent”), whose entire teachings are incorporated herein by reference. One or both woven base fabrics may be of the on-machine-seamable type. The addition of a fiber layer on top of the base fabric and needling it thereafter, however, involves conventional needling process, which includes passing the base fabric with the fiber layer on a needling bed where the needling board needles the staple fiber through the base fabric, thereby entangling the fibers with the base structure. This process, however, is not only time consuming and labor intensive, but also expensive.

U.S. Pat. Nos. 4,911,683 and 5,466,339 disclose press felts consisting of a base fabric with fiber batt material applied to one or both surfaces of the fabric. The fiber batt material is applied to the base fabric by conventional needling process or by adhesion using suitable adhesives or resins. The '683 patent also discloses sewing or stitching of the batt to the base fabric. These techniques, however, pose some serious limitations such as delamination and layer separation where there is no sewing.

Currently, most base support structures for press fabrics are manufactured mainly using tubular or endless weaving techniques which are known to those skilled in the art. With tubular weaving techniques, the base support structure is made in the form of an endless loop where the weft yarns, which form the MD yarns, are alternately passed into an upper warp yarn layer (upper cloth) and a lower warp yarn layer (lower cloth), which form the cross-machine direction (“CD”) yarns of the base support structure. The extent of this “tube” in the transverse direction of the weaving loom thus corresponds to half the length of the final base fabric. The width of the base support structure is determined by the weaving length. These known techniques, however, suffer from the following shortcomings.

First, the length of a tubular-woven base fabric is determined by the reed width in the weaving loom. A tubular-woven base fabric thus has a given length which cannot be modified significantly afterwards and which therefore, during the weaving operation, must be adjusted to precisely the papermaking press position in which the press fabric is to be used. Hence, the base support structure and thus the press fabric cannot be manufactured and kept in stock in standardized sizes, but must be manufactured for each specific order. This extends the delivery time and results in a low degree of utilization of the weaving equipment.

Second, when adapting a weaving-loom to form a longer base fabric, new warp threads must be inserted into the reed, which not only takes set-up time, but also involves time to adjust the loom in order to achieve uniform yarn tension in the warp threads.

Third, the weaving looms must be given a considerable width, up to 33 meters (m), to permit tubular weaving of all current lengths of base support structures. Therefore, the weaving looms are both large and expensive.

Fourth, weaving short length base support structures in a wide weaving loom results in wastage of warp yarn because not all warp threads are used, but yet must be fed through the loom during the weaving process.

Hence, there is a current need to solve the above-discussed problems in the prior art. The present invention overcomes the drawbacks of the conventional techniques discussed above and, therefore, is an advancement in the state of the art.

### SUMMARY OF THE INVENTION

It is therefore an object of the invention to provide a machine and method for achieving extremely rapid production rates of fabrics as compared to what is known in the prior art.

An object of the invention is to produce a multilayer textile structure, such as a press fabric, using a folding technique according to one embodiment of the present invention.

Another object of the present invention is to produce an MD oriented press fabric using MD yarn arrays to form a base support structure.

Yet another object of the invention is to eliminate much, if not all of the conventional needling process that is required to apply staple fiber that is necessary when producing similar fabrics with known prior art methods and machines.

Yet another object of the invention is to provide a machine and method where nonwoven fiber layers, especially staple fiber layers, can simultaneously be applied to a base support structure during the manufacturing assembly process.

A still further object of the invention is to provide a flexible manufacturing process, which requires a reduced number of personnel and machines.

These and other objects and advantages are provided by the instant invention. In this regard, one embodiment of the instant invention is directed to a machine and method of forming, for example, a press fabric. With the instant method, a base support structure having a width that is larger than the width of the final industrial fabric is constructed. For example, a single layer weave structure is formed by endless weaving. At least one layer of staple fiber batt material is then attached to one or both sides of the base support structure. After the layer of staple fiber batt material is attached, this structure is then folded over onto itself one or more times in a widthwise manner in order to produce a multi-layered structure. Finally, the layers of the multi-layered structure can be bonded to each other via bonding techniques known in the art, such as needling an additional layer of staple fiber onto the multilayer structure and/or use of heat and pressure or other means suitable for the purpose, thereby forming a laminated press fabric.

Another embodiment of the instant invention is directed to a method of forming an industrial fabric. With this method, a strip of yarn material, such as an MD yarn array with yarns oriented substantially in the MD of the fabric, is spirally wound onto two substantially parallel rolls to form a base support structure. The base support structure can also be formed by winding a system of yarn material flat from a roll of desired width to form an endless loop. The base support structure has a width which is greater than the width of the final fabric and has at least an additional layer of staple fiber batt material attached to one or both of its sides. Note the additional layer may be of woven material or may be a nonwoven material such as material that is airlaid, spunbond or even a polymeric film or layer of foam depending upon the particular application. Once the layer is attached, the base support structure is then folded over onto itself one or more times in a widthwise manner in order to produce a multi-layered structure. Finally, the layers of the multi-layered structure are bonded to each other by way of techniques disclosed above, thereby forming a laminated fabric structure of the desired length and width for the intended application.

It is important to note that, if a final fabric width of × is required, the initial base support structure is 3× wide if two “foldovers” are contemplated. The additional layer or layers, however, can be 1×, 2×, or 3× wide, depending upon the desired final structure.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which preferred embodiments of the invention are illustrated in the accompanying drawings in which corresponding components are identified by the same reference numerals.

### BRIEF DESCRIPTION OF THE DRAWINGS

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates a top view of a manufacturing machine, according to one embodiment of the invention;

FIG. 2 illustrates a top view of the manufacturing machine used in conjunction with an infrared heater, according to one embodiment of the invention;

FIG. 3 illustrates a profile view of the manufacturing machine according to yet another embodiment of the present invention;

FIG. 4 illustrates the “folding” technique, according to one embodiment of the present invention; and

FIG. 5 illustrates the “folding” technique, according to one embodiment of the present invention which includes an additional media layer between the folded fabric layers.

### DETAILED DESCRIPTION OF THE INVENTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description.

The invention according to one of its embodiments is a production method and machine for producing multi-layer endless fabrics via a multi-fold technique, which are described in detail in the following paragraphs.

The machine 100 according to one embodiment of the invention comprises a frame 90 including two substantially parallel rolls 20, 30, the distance between which can be adjusted to accept a variety of fabric lengths. The rolls 20, 30 may be heated or unheated. The system of rolls 20, 30 includes a main cylinder 30 and a stretch roll 20, which are spaced apart at approximately the desired operating length of the final fabric, that length being approximately the same whether the base support structure is an endless woven fabric, or if strips of fabric are spiral wound as in the '656 patent, or if an MD yarn system is to be wound, e.g., spirally wound around rolls 20, 30. Frame 90 can be of a width that far exceeds the widths of standard dryer frames common in the industry, which normally have a maximum width of 15 m. The far greater width allows for the production of very wide fabrics with a “folding” technique, which will be described in more detail below. For example, to produce a final fabric 10 meters in final width, a 20 meter wide frame can be used for a single fold. A 30 meter wide frame, for example, can be used to produce a 10 meter fabric that is folded twice, with each fold 10 meters wide, and so on.

The “stretch” roll of this machine can also be produced to allow “segmentation” of the roll and stretch mechanisms. This segmentation allows the utilization of the machine for numerous products at the same time, even if the products are of different lengths. This also allows for extremely efficient production and machine utilization as compared to conventional frames, which are limited to production of fabrics of the same length.

According to another embodiment of the invention, a fabric 10, which may be used in a papermaking machine or any other machine requiring a dewatering, transport, or finishing fabric or belt, may be produced on the above disclosed machine.

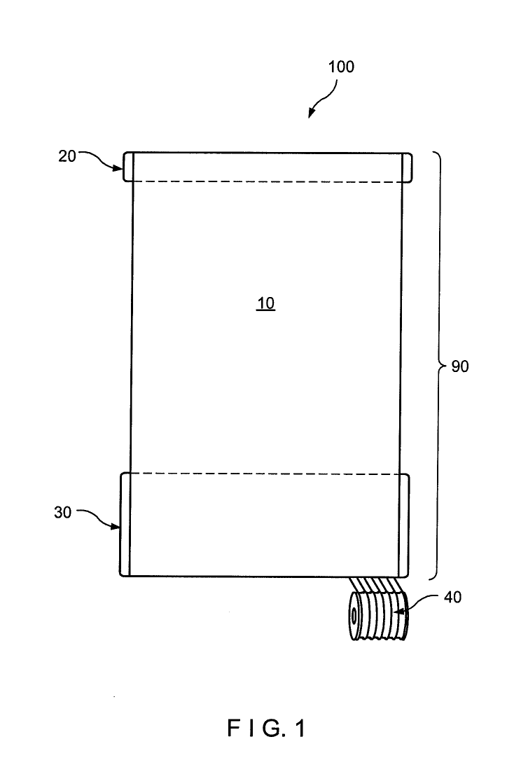

As illustrated in FIG. 1, support fabric 10 may be produced by way of a conventional weaving technique to form an endless woven structure with a width of an integer multiple of the required final fabric or belt. Support fabric 10 may also be produced by either feeding a yarn system, such as a MD yarn array or a woven product, knitted product, nonwoven such as a spun bond, a foam, CD yarn array or a film, onto rolls 20, 30 in order to produce a tubular or endless fabric. The fabric 10 can be laid either via a creel 40 (i.e. for yarns), or from a flat roll of a given width (i.e. for woven, knitted, nonwoven, foam, or film type materials) to form an endless loop. The endless loop can also be formed via a spiraling method, similar to that disclosed in the '656 patent. Support fabric 10 may also be formed in the form of a laminate by having an endless loop within an endless loop with both layers bonded together, such as for example, a top layer of endless woven structure with a bottom layer of one or more layers of spiral wound or flat fed MD or CD yarn array, a woven product, knitted product, nonwoven product, a foam, or a film, or vice versa. Support fabric 10 may also be a laminate formed by layering two or more layers of spiral wound or flat fed MD or CD yarn array, a woven product, knitted product, nonwoven product, a foam, or a film in an endless form. The fabric 10 may be made of yarns having a fusible component on the surface or within the yarn structure, such as for example, a bicomponent yarn in a sheath-core form, with the outer material having a lower melting temperature than the inner material. Support ropes, which are generally referred to as “cornealongs” in the art, are attached to one edge of the support fabric in CD for use in the “folding” technique, as described in this embodiment. After the support fabric is formed, an additional layer 45 of staple fiber batt, woven or nonwoven material as aforesaid, which may contain a meltable or glueable component, can be laid on the outside, inside or both sides of the support fabric 10 and bonded thereto, according to one embodiment of the invention.

The method according to one embodiment of the invention when using an MD yarn array, may involve application of the fiber batt layer or another nonwoven layer to keep the yarn orientation and spacing of the system of yarn material before winding it onto rolls 20, 30 of the machine frame. The layer 45 of staple fiber batt, woven or nonwoven material can be laid on the outside, inside or both sides of the support fabric 10 and bonded thereto. The winding process can be carried out by passing the system of yarn material over and/or under rolls 20, 30, in a continuous manner, according to one embodiment of the invention.

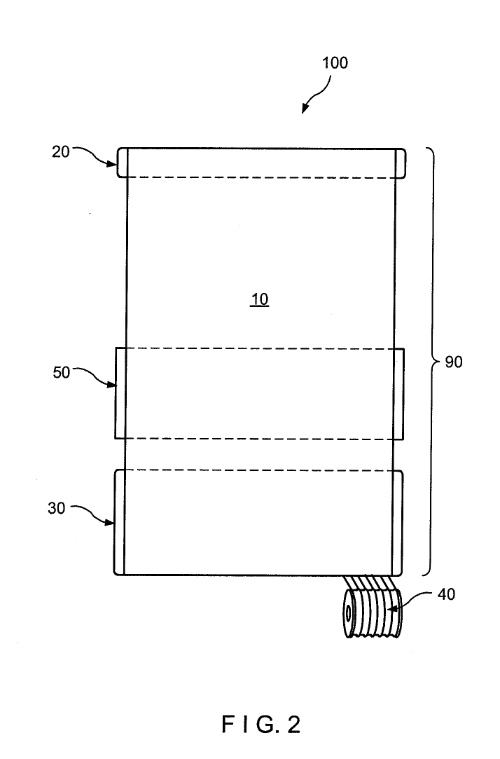

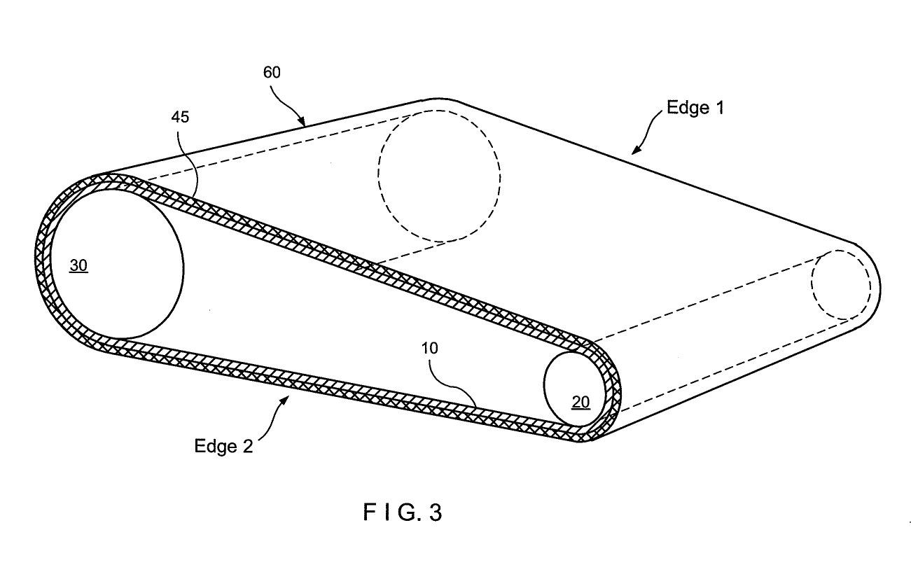

As shown in FIG. 2, according to one embodiment of the instant invention, one method of producing the fabric 10 uses an infrared heater 50 along with a press roll (not shown in figures), running between the two spaced rolls 20, 30, for adhering or bonding the additional layer of material 45 such as a woven, nonwoven, staple fiber batt or other media to the fabric 10. The bonding of the additional layer 45 may also be achieved using adhesives, such as for example polyvinyl alcohol (“PVA”), or fusible fibers, and a heat source having a heated cylinder roll 30 for example, a hot air blow box, an infrared heater, heated cylinder roll or any other suitable means known in the art for this purpose. This process may involve a needle roll or belt system with needles or a needling board mounted on the machine frame that can entangle fiber or other nonwoven material or media with enough entanglement to allow the fixing process to ensure proper bonding. The method results in a laminate precursor base support structure 60, as shown in FIG. 3, with the entire process completed on a single frame machine. This arrangement avoids the need to transfer the product to a conventional needling machine common in the paper machine clothing industry in order to apply layers of fibers onto both sides of the fabric. As seen in FIG. 3, this precursor is now continuous around roll 30 and is a continuous loop also encompassing roll 20.

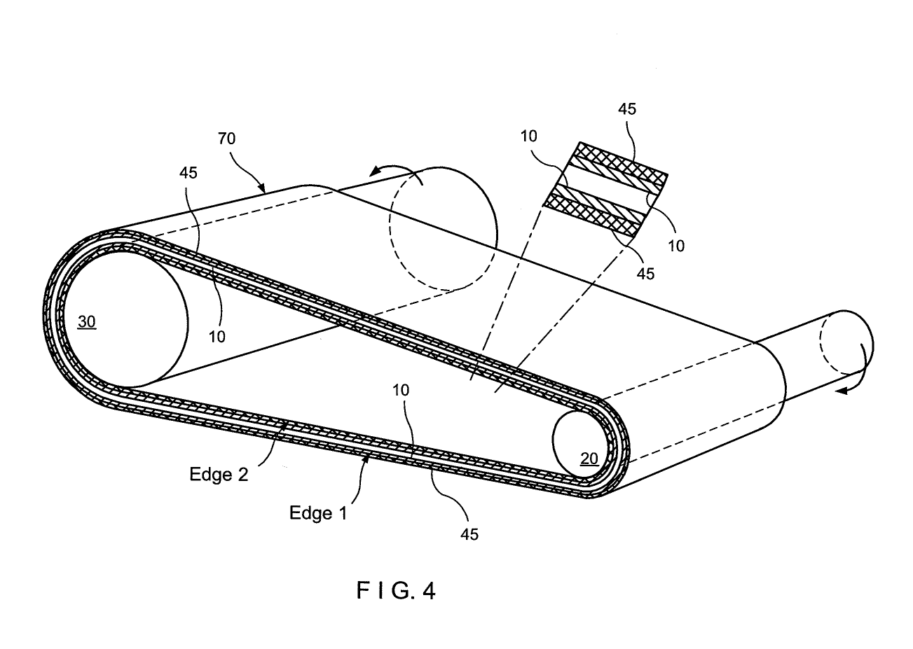

A base support structure 60 produced in accordance with the instant invention is produced at a width at least twice as wide as the final product dimensions, with widthwise edges 1 and 2 as shown in FIG. 3. The base support structure 60 can also be produced in three, four, or any integral multiple of the final fabric width in order to provide desired mass, void volume, strength, thickness, etc. After the bonding process that bonds the additional layer 45 and the support structure 10 together, the completed structure 60 is folded over onto itself in the direction of arrows as shown in FIG. 4 to produce a fabric 70 that is now a minimum of two distinct “layers” having the desired order of material 10 and 45 on the appropriate sides of the fabric 70 (i.e., the paper side and rollside or backside of the fabric). This “folding” technique is accomplished by flipping over one side of the fabric 60 onto the other, for example, by pulling the previously disclosed cornealongs towards the second edge, causing the fabric 60 to fold upon itself.

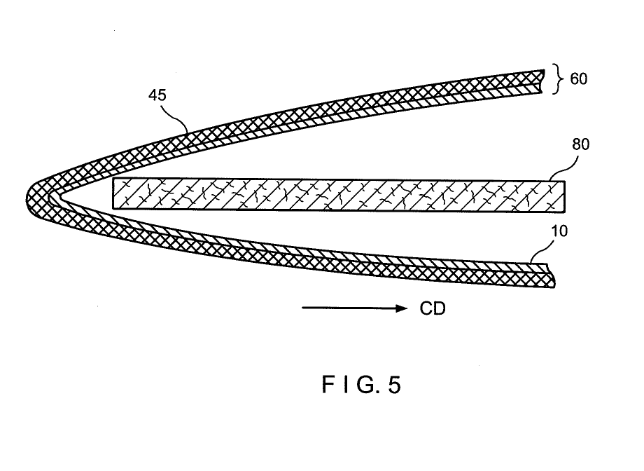

According to another aspect of the invention, a different media layer, such as a separate layer of staple fiber or a film, a foam or CD yarn array 80 as shown in FIG. 5, can be placed on base support structure 60, such that it is located between the folded fabric 70 in order to provide desired thickness, void volume, permeability, strength and/or other desired characteristics. The layer of staple fiber or film 80, for example, has a width equivalent to half the width of base structure 60 if the final fabric is a two-fold and one-third the width if the final fabric is a three-fold and so on. Layer 80 can be laid along either of the widthwise edges 1 and 2 of the base structure 60 before it is folded onto itself. However, the width of the layer of staple fiber or film 80 can also be equal to the width of the base support structure 60 if extra thickness or density is required. The layers of the multi-layered structure can be bonded to each other via bonding techniques known in the art, such as use of heat, pressure and/or adhesives thereby forming a laminated fabric. Note, while layer 80 is shown in “cut away” form, it is important to remember it is in the form of a loop as well, of the desired length of the final fabric and surrounds both rolls 20 and 30 in a continuous loop.

In another embodiment, a layer of a meltable fiber system 45 is provided and can be attached to the base support structure 60 which is then treated by way of the aforesaid needle roll or belt system, needle board or a device mounted on the machine frame. This would provide enough of the mixing of the meltable fiber system 45 throughout the structure, such that subsequent heat treating would provide enough bonding to lock the structure together. The meltable fiber system 45 may even be composed of a blend of first and second fibers that melt at different temperatures, allowing the adhesion of the fiber mass with the base structure in the first level of treating with the first fibers, and the second fibers, with a higher melting temperature, melted in the final stage in order to lock the entire structure together. For instance, meltable fibers melting at 115° C. and 140° C., respectively, may be used for this purpose. Bicomponent fibers, i.e., with a sheath-core or side-by-side structure, may also be used for this application. The final structure 70 can also be held together either by application of adhesives such as polyvinyl alcohol (“PVA”) or by just needling the layers together followed by subsequent use of heat as the layers include meltable material such as low melt fibers. Also, as previously stated, an additional staple fiber batt layer or layers can be added on the outer layer of the final fabric 70 in a conventional manner.

Thus, the disclosed method is advantageous over the prior art for at least the following reasons. The disclosed method provides for rapid production rates of multilayer, laminate structures, as compared to conventional techniques. The method also minimizes or entirely eliminates the need to use conventional needling process on a needling machine to apply fibrous layers, consolidate and hold the laminate together. In this process, the staple fibers layer(s) can simultaneously be applied during the spiral winding process and bonded via melting or gluing as opposed to the mechanical interlocking necessary with conventional needling processes, which as aforementioned typically requires the fabric to be transferred to another machine for this purpose.

In the embodiment of the invention involving MD oriented unwoven yarn array systems having at least two layers of the unwoven array of MD yarns in the resultant fabric, this may aid in increased fabric compressibility. This may be due to the lack of a weave, which provides the fabric with very little resistance to compressive forces. The increased fabric compressibility results in very fast “startups” on papermaking machine presses, normally manifesting itself in very fast nip dewatering. The fabric thus produced will have very little flow resistance in the machine direction of the fabric due to the “flow channels” produced by the multiple layers of MD oriented yarn systems.

A further advantage when utilizing any combination of layers described above that are not full width endless woven, is the complete lack of loom edges, joined CD seams, or other CD discontinuities, which are produced by other manufacturing techniques. The lack of loom edges, CD seams and other discontinuities results in a product that causes less sheet marking as well as a more uniformly produced fabric characteristics, such as uniform drainage across the entire fabric. Furthermore, the method of the present invention also offers a flexible manufacturing process, which requires a minimum number of personnel and machines.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A method of manufacturing an industrial fabric, comprising the steps of:
(a) forming a base support structure having a length approximately that of the final fabric and a width which is greater than a width of the final fabric and is an integer multiple of the width of the industrial fabric;
(b) folding the base support structure onto itself in a widthwise manner one or more times to form a multi-layered structure; and
(c) bonding the layers of the multilayered structure together to form a laminated fabric structure.

2. The method according to claim 1, wherein the base support structure is a conventional, endless woven structure.

3. The method according to claim 1, wherein the base support structure is formed by spirally winding a strip of material about at least two substantially parallel rolls.

4. The method according to claim 3, wherein said strip of material comprises yarns oriented substantially in the machine direction of the fabric in use.

5. The method according to claim 3, wherein the strip of material is woven, nonwoven, knitted, foam, CD yarn array, or film type of material.

6. The method according to claim 1, wherein said base support structure is a laminate including a top layer of endless woven structure and a bottom layer of one or more layers of spiral wound or flat fed MD or CD yarn array, a woven product, knitted product, nonwoven product, a foam, or a film, or vice versa,
wherein said top and bottom layers are bonded together.

7. The method according to claim 1, wherein said base support structure is a laminate including two or more layers of spiral wound or flat fed MD or CD yarn array, a woven product, knitted product, nonwoven product, a foam, or a film in an endless form,
wherein said two or more layers are bonded together.

8. The method according to claim 1, 6 or 7, wherein said base support structure is made of yarns comprising a fusible component on the surface or within the yarn structure.

9. The method according to claim 8, wherein said yarns include bicomponent yarns.

10. The method according to claim 1, 6 or 7, further comprising the step of attaching at least one or more layers of staple fiber material to one or both sides of the base support structure.

11. The method according to claim 10, wherein said staple fiber material includes staple fibers having different melting temperatures.

12. The method according to claim 10, wherein said staple fiber material includes bicomponent fibers.

13. The method according to claim 10, wherein said attaching is achieved using an infrared heater, adhesives, a heated cylinder roll, hot air blow box, a needling roll, a needle belt or a needling board mounted on a machine frame.

14. The method according to claim 13, wherein said adhesive is a polyvinyl alcohol.

15. The method according to claim 10, further comprising the step of:
inserting a layer of staple fiber, a film, a foam, CD array or other layer between the folded base support structure.

16. The method according to claim 15, wherein the layer of staple fiber, film, foam, CD array or other layer has a width equivalent to half, one-third or full-width of the base support structure.

17. The method according to claim 1 or 15, further comprising the steps of:
bonding the layers of the multi-layered structure using heat, pressure, needling and/or adhesives.

18. The method according to claim 17, further comprising the steps of:
attaching an additional layer of staple fiber batt on an outer layer of the laminated fabric structure.

19. An industrial fabric comprising:
(a) a base support structure having a length approximately that of the fabric and a width which is greater than the width of the final fabric and is an integer multiple of the width of the fabric;
wherein said base support structure is folded onto itself in a widthwise manner one or more times to form a multi-layered structure; and
wherein said layers of the multi-layered structure are bonded together to form a laminated fabric structure.

20. The fabric according to claim 19, wherein the base support structure is a conventional, endless woven structure.

21. The fabric according to claim 19, wherein the base support structure is a strip of material spirally wound about at least two substantially parallel rolls.

22. The fabric according to claim 21, wherein said strip of material comprises yarns oriented substantially in a machine direction of the fabric in use.

23. The fabric according to claim 21, wherein the strip of material is woven, nonwoven, knitted, foam, CD yarn array or film type of material.

24. The fabric according to claim 19, wherein said base support structure is a laminate including a top layer of endless woven structure and a bottom layer of one or more layers of spiral wound or flat fed MD or CD yarn array, a woven product, knitted product, nonwoven product, a foam, or a film, or vice versa,
wherein said top and bottom layers are bonded together.

25. The fabric according to claim 19, wherein said base support structure is a laminate including two or more layers of spiral wound or flat fed MD or CD yarn array, a woven product, knitted product, nonwoven product, a foam, or a film in an endless form,
wherein said two or more layers are bonded together.

26. The fabric according to claim 19, 24 or 25, wherein said base support structure is made of yarns comprising a fusible component on the surface or within the yarn structure.

27. The fabric according to claim 26, wherein said yarns include bicomponent yarns.

28. The fabric according to claim 19, 24 or 25, further comprising one or more layers of staple fiber material attached to one or both sides of the base support structure.

29. The fabric according to claim 28, wherein said staple fiber material includes staple fibers having different melting temperatures.

30. The fabric according to claim 28, wherein said staple fiber material includes bicomponent fibers.

31. The fabric according to claim 28, wherein said attaching is achieved using an infrared heater, adhesives, a heated cylinder roll, hot air blow box, a needling roll, a needle belt or a needling board mounted on a machine frame.

32. The fabric according to claim 31, wherein said adhesive is a polyvinyl alcohol.

33. The fabric according to claim 28, further comprising:
a layer of staple fiber, a film, a foam, CD array or other layer inserted between the folded base support structure.

34. The fabric according to claim 33, wherein the layer of staple fiber, film, foam, CD array or other layer has a width equivalent to half, one-third or full-width of the base support structure.

35. The fabric according to claim 19 or 33,
wherein the layers of the multi-layered structure are bonded together using heat, pressure, needling and/or adhesives.

36. The fabric according to claim 35, further comprising:
an additional layer of staple fiber batt attached on an outer layer of the laminated fabric structure.

37. A method of forming an industrial fabric, said method comprising the steps of:
(a) winding a strip of yarn material onto two substantially parallel rolls to form a base support structure having a length approximately that of the final fabric, said base support structure comprising yarns oriented in a machine direction of the fabric and a width which is larger than a width of the final fabric and is an integer multiple of the width of the industrial fabric; and
(b) folding the base support structure in a widthwise fashion onto itself one or more times to form a multi-layered structure.

38. An apparatus for producing an industrial fabric comprising:
a frame including a system of two or more substantially parallel rolls, the frame having a width substantially larger than a width of the final fabric,
wherein a distance between the rolls can be adjusted to accept a variety of fabric lengths,
wherein the rolls may be heated or unheated,
wherein the system of rolls includes a main cylinder and a stretch roll, and
wherein the stretch roll is segmented.
